(19) United States
(12) Patent Application Publication
(10) Pub. No.: US 2006/0192391 A1
(43) Pub. Date: Aug. 31, 2006

(54) Integrated tilt/sash lock assembly

(76) Inventors: Dean Pettit, St. John, IN (US); Edward C. Flory, Crown Point, IN (US)

Correspondence Address: WALLENSTEIN & WAGNER, LTD., 311 SOUTH WACKER DRIVE, 53RD FLOOR, CHICAGO, IL, 60606, US

(21) Appl. No.: 11/351,354

(22) Filed: Feb. 10, 2006

Related U.S. Application Data
(60) Provisional application No. 60/651,802, filed on Feb. 10, 2005.

(51) Int. Cl. E05C 9/00

(52) U.S. Cl. 292/5

(57) ABSTRACT

An integrated sash lock and tilt latch assembly is mounted in a sash window having a top rail, a base, and two stiles connected together at their extremities. The integrated assembly contains a sash lock mechanism, a tilt latch mechanism, and a connector. The sash lock mechanism includes an actuator movable to adjust the assembly among a locked position, an unlocked position, and a tiltable position, a rotor coupled to the actuator and having a locking cam, and a keeper that receives at least a portion of the locking cam in the locked position. The tilt latch mechanism includes a latch bolt housing supported by the top rail such that a top surface of the latch bolt housing is substantially flush with a top surface of the top rail, a latch bolt slidably disposed within the latch bolt housing, and a spring biasing the latch bolt outwardly from the housing. The connector has a first end of operably coupled to the latch bolt and a second end operably coupled to the sash lock mechanism.

### CROSS-REFERENCE TO RELATED APPLICATIONS

This application claims the benefit of U.S. Provisional Application Ser. No. 60/651,802, filed Feb. 10, 2005, which is incorporated by reference herein and made a part hereof.

### TECHNICAL FIELD

The present invention relates to sash window hardware and, more particularly, to an integrated sash lock and tilt-latch for use in sash windows.

### BACKGROUND OF THE INVENTION

A pivotal sash window adapted for installation in a master frame of a sash window assembly is well-known. The pivotal sash window assembly typically has opposed, vertically extending guide rails to enable vertical reciprocal sliding movement of the sash window in the master frame while cooperatively engaged with the guide rails. The sash window also has a top sash rail, a base and a pair of stiles cooperatively connected together at adjacent extremities thereof to form a sash frame, usually a rectangular frame.

Hardware is associated with the sash window assembly, such as a sash lock that provides a locking mechanism between an upper sash window and a lower sash window, as well as tilt-latches that releasably engage the guide rails to allow the sash window to pivot from the master frame. Mechanisms have been developed that combine the sash lock mechanism and the tilt-latch mechanism. While such combined mechanisms provide a number of advantageous features, they nevertheless have certain limitations. The present invention seeks to overcome certain of these limitations and other drawbacks of the prior art, and to provide new features not heretofore available.

### SUMMARY OF THE INVENTION

The present invention provides an integrated sash lock and tilt-latch assembly for a sash window assembly. The sash window assembly has a sash window slideable within a master frame. The sash window has a top rail, a base, and two stiles connected together at their extremities. The integrated assembly includes a sash lock mechanism, a tilt latch mechanism, and a connector. The sash lock mechanism includes an actuator movable to adjust the assembly among a locked position, an unlocked position, and a tiltable position, a rotor coupled to the actuator and having a locking cam, and a keeper that receives at least a portion of the locking cam in the locked position. The tilt latch mechanism includes a latch bolt housing supported by the top rail such that a top surface of the latch bolt housing is substantially flush with a top surface of the top rail, a latch bolt slidably disposed within the latch bolt housing, and means for biasing the latch bolt outwardly from the housing. The connector has a first end operably coupled to the sash lock mechanism and a second end operably coupled to the latch bolt.

According to one aspect of the invention, the latch bolt housing contains a longitudinal groove adapted to receive a header rail of the top rail to support the latch bolt housing within a cavity in the sash window. In one preferred embodiment, the groove is continuous along a side wall of the housing.

According to another aspect of the invention, the latch bolt housing has an opening receiving the connector therethrough. The latch bolt housing includes a cover and a rear wall depending from the cover, and the opening is positioned in the rear wall.

According to another aspect of the invention, the latch bolt housing includes a longitudinal rail adapted to be received in a slot in the sash window to support the latch bolt housing within a cavity in the sash window. The latch bolt housing further comprises a cover having a longitudinal edge, and the longitudinal edge and the longitudinal rail define a longitudinal groove therebetween. The longitudinal groove is configured to receive a header rail of the top rail to support the latch bolt housing within the cavity in the sash window.

According to another aspect of the invention, the sash lock mechanism further includes a pawl operably associated with the actuator. The pawl operably engages the rotor and an end of the connector is connected to the pawl. The pawl includes a base having a tab and an appending member extending therefrom, wherein the rotor abuttingly engages the tab and the end of the connector is connected to the appending member.

According to another aspect of the invention, the actuator is moveable among a first position wherein the rotor does not abuttingly engage the pawl and the assembly is in the locked position, a second position wherein the rotor abuttingly engages the pawl and the assembly is in the unlocked position, and a third position wherein the rotor abuttingly engages the pawl and the assembly is in the tiltable position. The abutting engagement of the rotor and the pawl causes the rotor and the pawl to rotate together between the second position and the third position.

According to another aspect of the invention, the actuator is moveable through a first range of angular movement, wherein movement of the actuator rotates the rotor, and a second range of angular movement, wherein the rotor abuttingly engages the pawl such that movement of the actuator rotates the rotor and the pawl together.

According to another aspect of the invention, the latch bolt housing includes a stile-engaging member extending from the housing and having a plurality of engaging surfaces thereon, each of the engaging surfaces configured to engage an inner surface of one of the stiles. The stile-engaging member includes a flexible and resilient leg extending from the housing, and the leg is configured to flex when the housing is inserted into the top sash rail. The latch bolt housing further includes a cut-out portion proximate the leg, allowing the leg to flex upwardly.

According to another aspect of the invention, the integrated assembly includes an actuator movable to adjust the assembly among a locked position, an unlocked position, and a tiltable position, a rotor coupled to the actuator and having a locking cam, a pawl, a keeper that receives at least a portion of the locking cam in the locked position, a latch bolt slidably disposed within the sash window, means for biasing the latch bolt outwardly, and a connector having a first end and an opposed second end. The pawl includes a base and an appending member extending downward and outward from the base. The first end of the connector is operably coupled to the appending member of the pawl and the second end of the connector is operably coupled to the latch bolt. The actuator is moveable among a first position wherein the rotor does not abuttingly engage the pawl and the assembly is in the locked position, a second position wherein the assembly is in the unlocked position, and a third position wherein the rotor abuttingly engages the pawl and the assembly is in the tiltable position.

A tilt latch housing for a sash window having a top rail, a base, and two stiles connected together at their extremities is also disclosed. The housing is supported by the top rail proximate one of the two stiles. The housing includes a body configured to slidably receive a latch bolt therein and a stile-engaging member extending from the body. The stile-engaging member has a plurality of engaging surfaces thereon, and each of the engaging surfaces is configured to engage an inner surface of the stile.

According to another aspect of the invention, the stile-engaging member is a flexible and resilient leg extending from the housing, and the leg is configured to flex when the housing is inserted into the top sash rail. The body further includes a cut-out portion proximate the leg, allowing the leg to flex upwardly.

According to another aspect of the invention, the plurality of engaging surfaces are a plurality of teeth substantially aligned along a length of the stile-engaging member.

According to another aspect of the invention, the integrated assembly is used in a sash window assembly having a lower sash window and an upper sash window slideable within a master frame. The lower sash window has a top rail, a base, and a pair of stiles connected together at their extremities, the top rail has a pair of header rails, and the upper sash window has a keeper. The integrated assembly includes a sash lock mechanism, a tilt latch mechanism, and a connector. The sash lock mechanism includes an actuator supported by the lower sash window and a rotor connected to the actuator. The tilt latch mechanism includes a latch bolt housing having mounting structure receiving the header rails of the top rail of the lower sash window, a latch bolt slidably disposed within the latch bolt housing, and a means for biasing the latch bolt outwardly from the housing. The connector has a first end operably coupled to the sash lock mechanism and a second end operably coupled to the latch bolt. The actuator is moveable between a locked position wherein the rotor is adapted to engage the keeper, an unlocked position wherein the rotor is adapted to be disengaged from the keeper, and a tiltable position wherein the connector retracts the latch bolt into the latch bolt housing.

According to another aspect of the invention, the latch bolt housing has a pair of side walls, each side wall having a groove adapted to receive a header rail of the top rail.

According to another aspect of the invention, the latch bolt housing has a rear wall having an opening, wherein the connector extends through the opening.

According to another aspect of the invention, the latch bolt housing has a stile-engaging member having a plurality of engaging surfaces thereon, each of the engaging surfaces adapted to engage an inner surface of the stile.

These and other objects and advantages will be made apparent from the following description of the drawings and detailed description of the invention.

### BRIEF DESCRIPTION OF THE DRAWINGS

To understand the present invention, it will now be described by way of example, with reference to the accompanying drawings in which:

FIG. 1 is a perspective view of a sash window assembly incorporating an integrated tilt/sash lock assembly of the present invention;

FIG. 2 is an elevation view of an integrated tilt/sash lock assembly of the present invention;

FIG. 3 is a front-bottom perspective view of a sash lock of the assembly of FIG. 2 and also partially showing a connector;

FIG. 4 is a bottom view of the sash lock of FIG. 3;

FIG. 5 is a rear-bottom perspective view of the sash lock of FIG. 3;

FIG. 6 is an elevation view of the sash lock of FIG. 3;

FIG. 7 is a rear-bottom perspective view of a tilt-latch of the assembly of FIG. 2;

FIG. 8 is a bottom view of the tilt-latch of FIG. 7;

FIG. 9 is an elevation view of the integrated tilt/sash lock assembly of FIG. 2 inserted into a sash window with a stile having a relatively narrow thickness;

FIG. 10 is an elevation view of the integrated tilt/sash lock assembly of FIG. 2 inserted into a sash window with a stile having a relatively wide thickness;

FIG. 11 is a top view of another embodiment of an integrated tilt/sash lock assembly of the present invention inserted into a top rail of a sash window, shown in the locked position;

FIG. 12 is a top view of the integrated tilt/sash lock assembly of FIG. 11, shown in the unlocked position;

FIG. 13 is a top view of the integrated tilt/sash lock assembly of FIG. 1, shown moving from the unlocked position to the tiltable position;

FIG. 14 is a perspective view of the integrated tilt/sash lock assembly of FIG. 11 inserted into a top rail of a sash window, shown with a keeper;

FIG. 15 is an elevation view of the integrated tilt/sash lock assembly of FIG. 14;

FIG. 16 is a reverse elevation view of the integrated tilt/sash lock assembly of FIG. 14;

FIG. 17 is a bottom view of the integrated tilt/sash lock assembly of FIG. 14;

FIG. 18 is a bottom perspective view of the integrated tilt/sash lock assembly of FIG. 14;

FIG. 19 is an end view of the integrated tilt/sash lock assembly of FIG. 14 installed in a top rail of a sash window;

FIG. 20 is a bottom perspective view of a sash lock mechanism of the integrated tilt/sash lock assembly of FIG. 14;

FIG. 21 is a perspective view of a pawl of the integrated tilt/sash lock assembly of the present invention;

FIG. 22 is a bottom perspective view of a rotor of the integrated tilt/sash lock assembly of the present invention;

FIG. 22A is a perspective view of the rotor of FIG. 22;

FIG. 23 is a perspective view of a portion of the integrated tilt/sash lock assembly of FIG. 14, including a cam engaged with a keeper;

FIG. 24 is a bottom perspective view of a portion of a latch bolt and a connector of the integrated tilt/sash lock assembly of FIG. 14;

FIG. 25 is a bottom view of a portion of a tilt latch mechanism of the integrated tilt/sash lock assembly of FIG. 14;

FIG. 26 is a bottom perspective view of a latch bolt housing of the integrated tilt/sash lock assembly of FIG. 14; and

FIG. 27 is a perspective view of a connector of the integrated tilt/sash lock assembly of FIG. 14.

### DETAILED DESCRIPTION

While this invention is susceptible of embodiment in many different forms, there is shown in the drawings, and will herein be described in detail, preferred embodiments of the invention with the understanding that the present disclosure is to be considered as an exemplification of the principles of the invention and is not intended to limit the broad aspect of the invention to the embodiments illustrated.

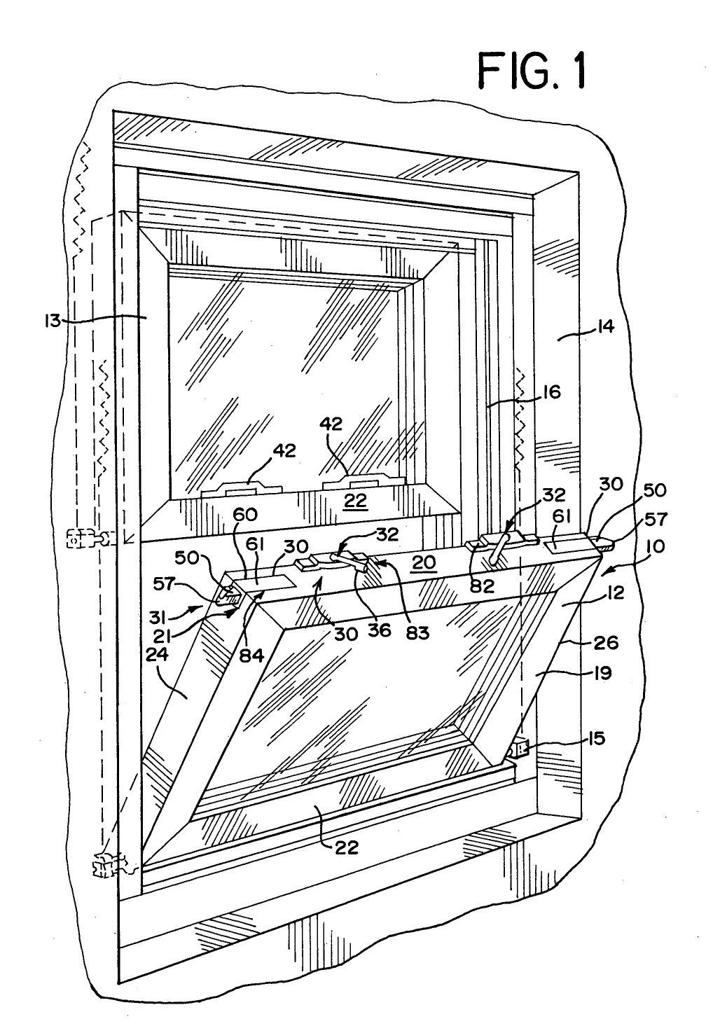

A sash window assembly 10 is shown in FIG. 1. The sash window assembly 10 is a double-hung window assembly having a pivotal sash window 12 installed in a master frame 14. The sash window 12 is pivotally mounted to the master frame 14 by a pivot-corner/balance shoe assembly 15. The master frame 14 has opposed, vertically extending guide rails 16. The sash window 12 has a top sash rail 20, a base 22 and a pair of stiles 24,26, cooperatively connected together at adjacent extremities thereof to form a sash frame 19, typically rectangular although other shapes are possible. The sash frame 19 with which the integrated assembly 30 described herein is employed is typically made from vinyl extrusions known in the art. While the present invention can be used with any type of frame 19, the present invention is most preferably used with a window assembly 10 having a frame 19 made of vinyl. Further, it is contemplated that the frame 19 could be made from wood, masonite or press board, or from extrusions or pulltrusions that are filled with fiberglass, epoxy, plastic, or wood chips, or from other materials, including aluminum.

In accordance with one embodiment of the invention, the sash frame assembly includes an integrated tilt/sash lock assembly 30. The integrated assembly 30 provides a sash locking operation. Additionally, the integrated assembly 30 provides a tilt-latch operation. While the integrated assembly 30 will be described herein with respect to a single integrated assembly 30, the integrated assembly 30 can also be used in connection with a dual integrated assembly. In such an instance, the second half of the integrated assembly will be substantially the same as that half of the integrated assembly 30 described herein. Also, as can be understood from FIG. 1, a preferred embodiment of the invention has a left-side integrated assembly 30 and a right-side integrated assembly 30.

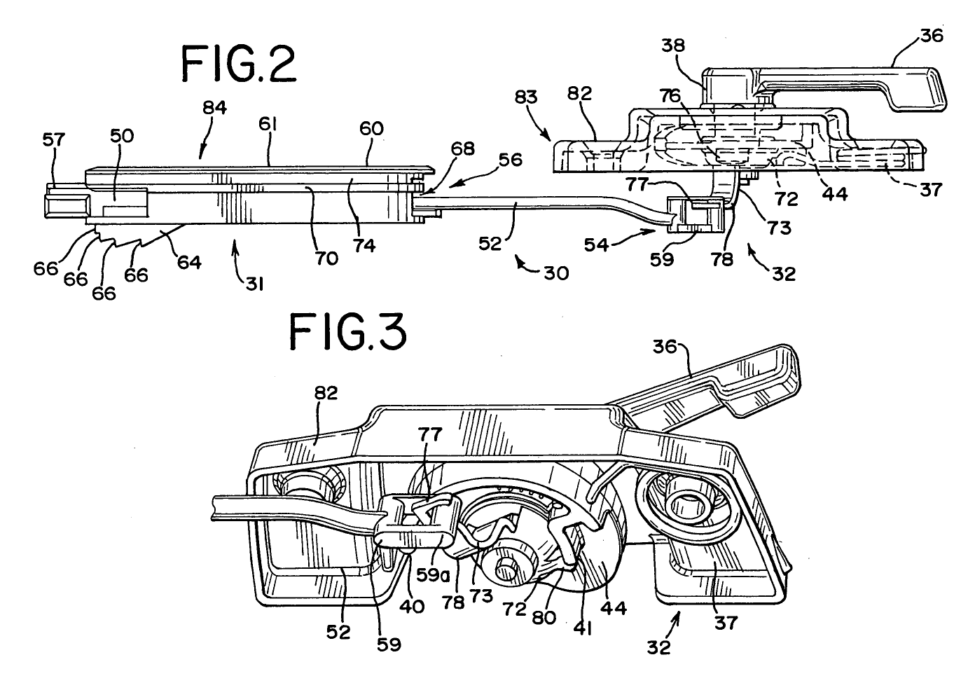

Referring to FIGS. 1-2, the integrated tilt/sash lock assembly 30 generally includes a sash lock mechanism 32 and a tilt-latch mechanism 31. The sash lock mechanism 32 includes a cam or rotor 44 operably associated with a pawl 72 that has a pawl member 78. The tilt-latch mechanism 31 includes a housing 60 having a rear opening 68 and a latch bolt 50 disposed in the housing 60. A connector 52 also preferably forms part of the assembly 30. The connector 52 has a first end 54 operably associated with the sash lock mechanism and preferably with the pawl member 78, and a second end 56 passing through the rear opening 68 of the housing 60 and connected to the latch bolt 50.

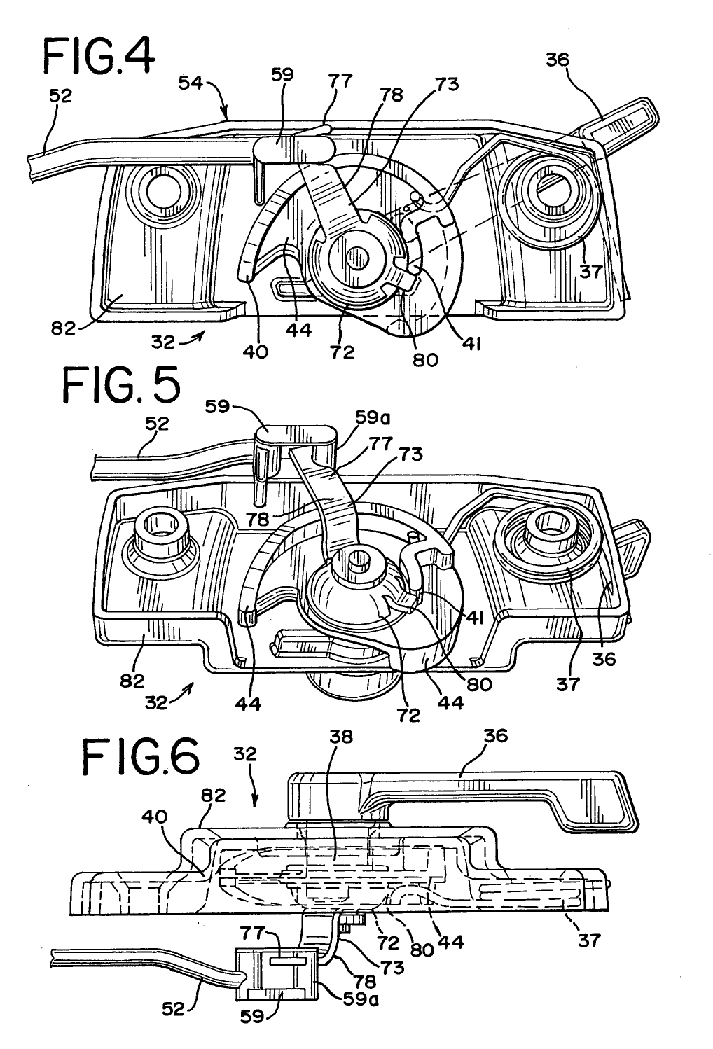

Referring to FIGS. 2-6, the sash lock mechanism 32 includes an actuator arm 36 connected via a shaft 38 to the cam 44. The cam 44 preferably includes an abutment member 41 and a locking member 40 configured to engage a keeper or locking bracket 42 (FIG. 1). The sash lock mechanism 32 also includes the pawl 72 that is comprised of a base 76 and a pawl member or appending member 78. The pawl 72 is operably associated with the connector 52 that extends away from the sash lock mechanism 32 to the tilt-latch mechanism 31. Preferably, the pawl 72 is directly connected to the connector 52, and the appending member 78 contains a hook 77 that engages a hitch 59 on the connector 52, as illustrated in FIGS. 2-6. In this embodiment, the hitch 59 includes a vertical bar 59a that the hook 77 is able to latch onto. The base 76 includes a tab 80 extending outwardly from an outer surface of the pawl 72. The cam 44 and the pawl 72 are disposed proximate one another in operable association with each other. Movement of the actuator arm 36 causes the cam 44 to rotate. Preferably, the cam 44 rotates freely and independently of the pawl 72 for a portion of the range of rotation. However, at a point in the rotation, the abutment member 41 of the cam 44 abuttingly engages the tab 80 of the pawl 72, such that when engaged, the cam 44 and the pawl 72 generally rotate in unison. Thus, the actuator 36, the cam 44, and the pawl 72 are all operably associated with each other.

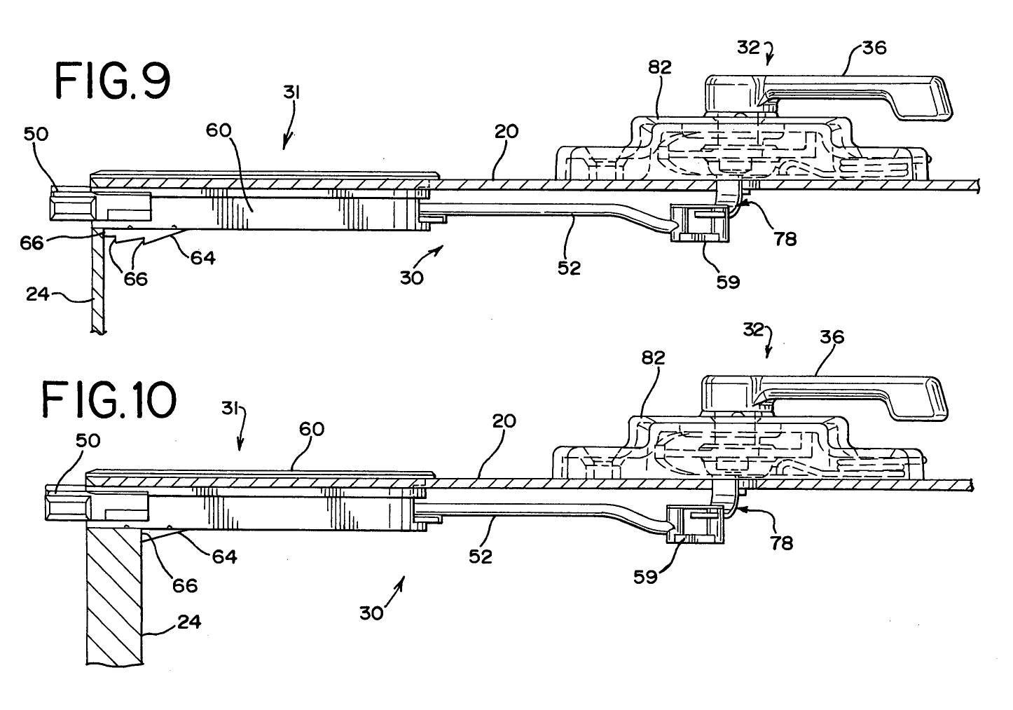

A sash lock housing 82 covers and helps support the other components of the sash lock mechanism 32, and is designed to be attached to the top sash rail 20, as illustrated in FIG. 1. As shown in one embodiment illustrated in FIGS. 1 and 2, the sash lock housing 82 may be disposed in a first location 83 of the sash rail 20 that is both laterally and vertically offset from, or misaligned with, a second location 84 of the sash 20 rail in which the latch bolt housing 60 is disposed. In this embodiment, the appending member 78 of the pawl 72 extends downwardly and outwardly from the pawl base 76, and preferably includes a step portion 73. As shown in FIG. 2 and also FIGS. 9-10, the sash lock mechanism is mounted proximate the first location 83, which is at a higher location in the top sash rail 20, preferably above the top sash rail 20. The base 76 of the pawl 72, as well as other components of the sash lock mechanism 32, are preferably mounted proximate the first location 83. The step portion 73 allows the latch bolt housing 60 to be mounted at the second location 84, which is at a lower depth in the rail 20 than the sash lock housing 82. Such a configuration facilitates a channel in the sash window rail 20 of sufficient depth to secure the latch bolt housing 60 with minimal compromise to the structural integrity of the rail 20. It is understood that the step portion 73 can vary for different assembly configurations, and that the appending member 78 of the pawl can extend downwardly and outwardly without a clearly defined step portion 73.

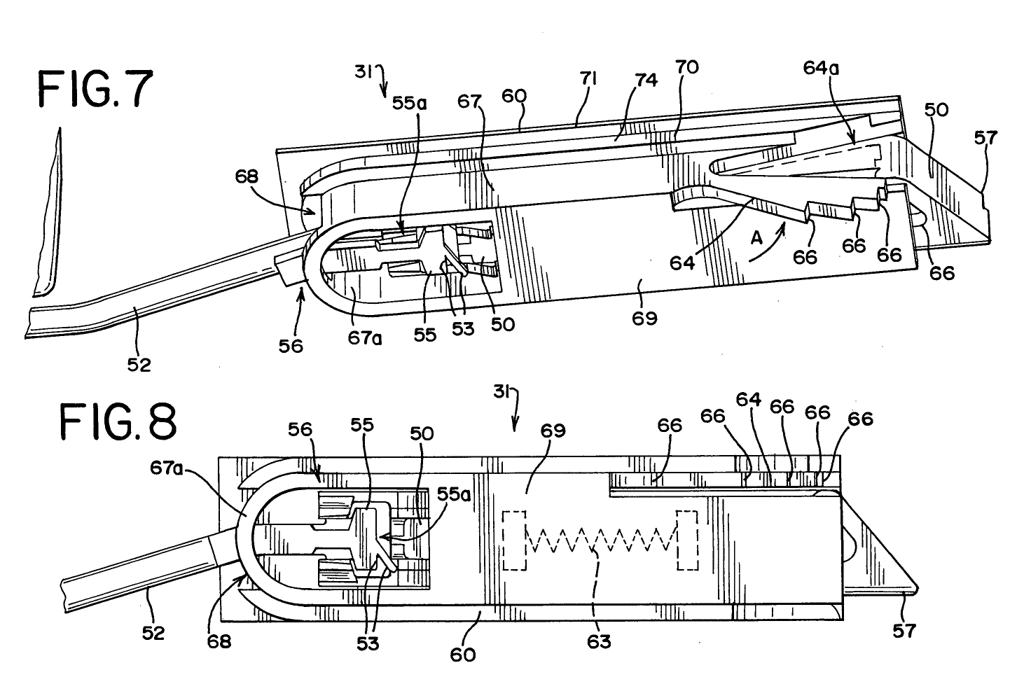

Referring to FIGS. 1 and 7-8, the tilt-latch mechanism 31 includes a latch bolt 50 disposed within a housing 60 and coupled to the connector 52 and a means for biasing the latch bolt outwardly, which is preferably a spring 63 (shown schematically in FIG. 8). It is understood the spring 63 is generally positioned between the latch bolt 50 and the housing 60 to bias the latch bolt 50 out of the housing 60. The tilt latch mechanism 31 is preferably disposed within the sash window 12, preferably within a cavity 21 in the sash window 12 that extends through both the stile 24,26 and the top sash rail 20. The housing 60 is used to support the latch bolt 50 within the top sash rail 20, and is preferably flush-mounted within the top sash rail 20, as shown in FIGS. 1, 9, and 10. The latch bolt 50 is able to slide within the housing 60 between a retracted position, wherein the tip 57 of the latch bolt 50 is retracted into the housing 60, and an outwardly-extended position, wherein the tip 57 of the latch bolt 50 extends beyond the end of the housing 60 and beyond the edge of the stile 24,26. When the sash window 12 is closed, the latch bolt 50 engages one of the guide rails 16 in the outwardly-extended position. The spring 63 biases the latch bolt 50 towards the outwardly-extended position. The connector 52 connects to the latch bolt 50, preferably by a snap-fit connection 55, as illustrated in FIGS. 7-8. The latch bolt 50 preferably has a recess 55a to receive the end 56 of the connector 52 and create the snap-fit connection 55.

The body 65 of the housing 60 preferably includes a cover 61, a pair of side walls 67 depending from the cover 61, and a bottom wall 69 extending inward from the side wall 67. A generally arcuate rear wall 67a also depends from the cover 61. It is understood that the walls can be supported in other various configurations to form the housing 60. The cover 61 is preferably rectangular in shape and has an outer edge 71 overhanging the side wall 67, so that the side wall 67 depends inward from the outer edge 71. The side wall 67 is preferably straight along the sides of the housing 60 and preferably is connected to the rear wall 67a that is curved along the back end of the housing 60. At the front end of the housing 60, a gap in the side wall 67 preferably exists to form a front opening 62 that allows the latch bolt 50 to extend out of the housing 60. The housing 60 preferably has at least one continuous longitudinal rail extending along the side wall 67, and preferably has two continuous longitudinal rails 70, each extending down one side of each side wall 67. The housing 60 may also have a continuous single rail 70 that extends completely around the side walls 67 and the rear wall 67a, or the rail or rails 70 may be broken or otherwise non-continuous. In the preferred embodiment, a continuous longitudinal groove 74 extending around the side wall 67 is formed between the rails 70 and the edge 71 of the cover 61. Like the rail(s) 70, the groove 74 may be continuous or broken, and may consist of several separate grooves 74. The combination of the rail 70 and groove 74 functions as mounting structure to support the housing 60 within the sash window 12. Preferably, a portion 23 of the top sash rail 20 is received in each groove 74. In a preferred embodiment, the top rail defines a pair of header rails and each header rail is received by the longitudinal groove 74. It is understood that the housing 60 may have a different shape or configuration, and may have another manner and structure for mounting within the sash window 12.

Additionally, the housing 60 preferably contains a rear opening 68, allowing the connector 52 to pass through and connect to the latch bolt 50. The rear opening 68 is preferably defined within the rear wall 67a of the housing 68, opposite the tip 57 of the latch bolt 50, and is preferably a rectangular hole, as illustrated in FIGS. 7-8. In the preferred embodiment, the opening 68 is completely bounded by the side wall 67 and the rear wall 67a, i.e. the opening 68 is surrounded on all sides by the material of the rear wall 67a. If desired, the opening 68 can extend into the side walls 67. In another embodiment, the opening 68 is completely bounded by the side wall 67, rear wall 67a, and the cover 61. However, the rear opening 68 can also take the form of a slot or a groove in the rear portion of the housing which extends completely through to the bottom of the rear wall 67a, and can be shaped differently as well. The opening 68 can also be positioned in other portions of the housing 68.

The housing 60 also includes a stile-engaging member 64 having a stepped configuration to define a plurality of engaging surfaces 66. Preferably, stile engaging member 64 is a flexible, resilient leg 64 extending downwardly and outwardly from the body 65 of the housing 60, and the engaging surfaces 66 are a plurality of teeth 66 aligned along the leg 64. Each of the plurality of engaging surfaces 66 allows the housing to engage a stile 24,26 of different thickness, increasing the versatility of the tilt-latch 31. The housing 60 is shown engaging stiles 24,26 of different thicknesses in FIGS. 9-10, which illustrate the flexing of the stile-engaging member 64 as it abuts the stile 24,26. The stile-engaging member 64 is preferably flexible and resilient. Accordingly, it is able to bend to allow the tilt-latch mechanism 31 to be inserted into the top sash rail 20 without being permanently deformed. Thus, a single housing 60 design can be used with multiple sash window designs. The housing 60 also includes a cut-out portion 64a proximate the stile-engaging member 64, which provides ample room for the stile-engaging member to flex upward during insertion of the tilt latch 31 into the sash window 12. Preferably, the cut-out portion 64a is dimensioned cooperatively with the stile-engaging member 64, so that the stile-engaging member 64 can easily flex into the cut-out portion 64a. It can be understood from FIGS. 7, 9 and 10 that the stile-engaging member can flex upwards in the direction of arrow A (FIG. 7) when installed into a sash window having stile with a greater thickness.

The connector 52 preferably connects the tilt-latch mechanism 31 and the sash lock mechanism 32, and has a first end 54 and a second end 56. The first end 54 of the connector 52 is operably associated with the pawl 72, preferably by engaging the appending member 78 of the pawl 72. As described above, the connector 52 preferably has a hitch 59 that engages a hook 77 on the appending member 78 of the pawl 72. The second end 56 of the connector 52 is connected to the latch bolt 50, preferably by passing through the rear opening 68 of the housing 60 and forming a snap-fit connection 55 with the latch bolt, as described above and illustrated in FIGS. 7-8. According to one embodiment of the present invention, the connectors 52 are flexible cords. It is preferred, however, that the connectors 52 are instead rigid or semi-flexible connecting rods. The rigid or semi-flexible connector 52 preferably has a bend in the middle to prevent interference between the connector 52 and mounting structure for the sash lock mechanism 32. As illustrated in FIGS. 7-8, the second end 56 of the connector 52 preferably has several resilient bracing arms 53 extending therefrom. When the connector end 56 is snapped into the latch bolt 50, the bracing arms 53 exert directional forces on the latch bolt 50, thus bracing the connector 52 against excessive movement during operation of the assembly 30. In particular, the bracing arms 53 exert a downward force or torque on the connector 52, tending to push the first end 54 of the connector downward. Pushing the first end 54 of the connector downward helps assure that the connector 52 remains in the proper position for connection to the sash-lock mechanism 32, facilitating a user in making a blind connection between the two.

As described in greater detail below, the integrated assembly 30 is moveable between a locked position, an unlocked position, and a tiltable position. In the locked position, the locking member 40 of the rotor 44 engages the keeper 42 and the latch bolt 50 is in the outwardly-extended position, engaging the guide rail 16 of the sash window 12. Thus, the window 12 is prevented from sliding or tilting. As the actuator 36 is moved from the locked position to the unlocked position, the rotor 44 rotates independently of the pawl 72. In the unlocked position, the rotor 44 is disengaged from the keeper 42, but the latch bolt 50 remains in the outwardly-extended position. Thus, the window 12 can slide within the frame 14, but cannot tilt. As the actuator 36 is moved from the unlocked position to the tiltable position, the abutment member 41 of the rotor 44 abuttingly engages the tab 80 of the pawl 72, such that when engaged, the rotor 44 and the pawl 72 generally rotate in unison. Rotation of the pawl 72 retracts the latch bolt 50. In the tiltable position, the latch bolt 50 is retracted, allowing the window 12 to tilt.

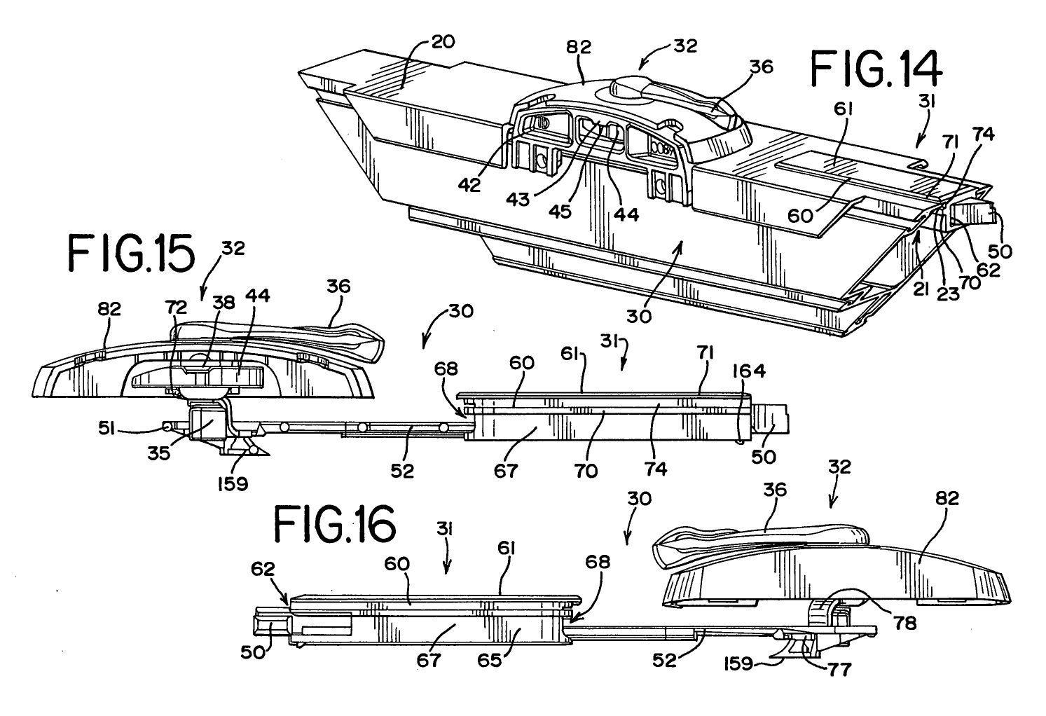

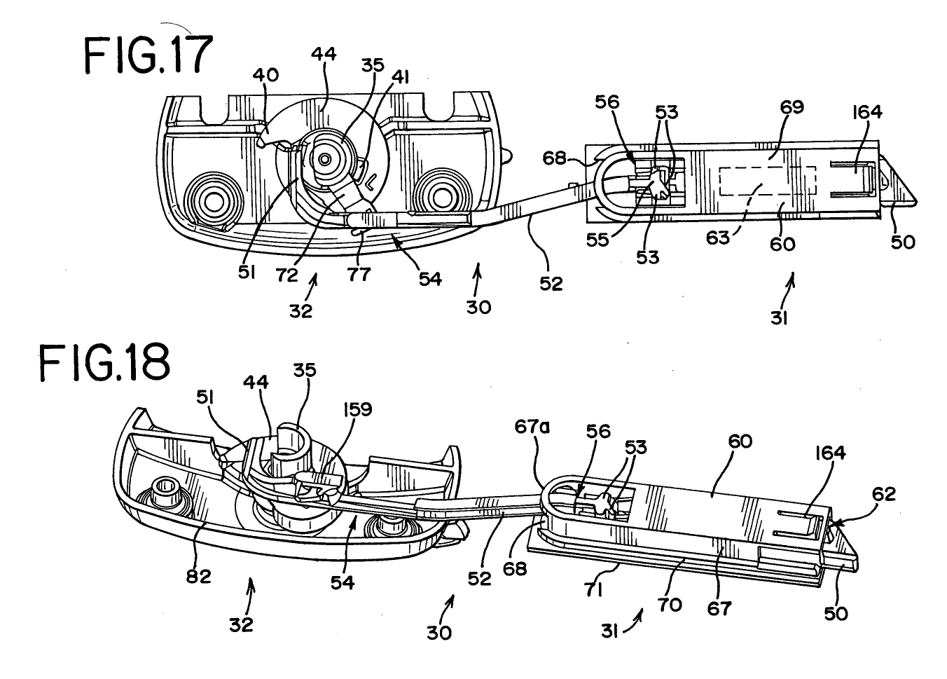

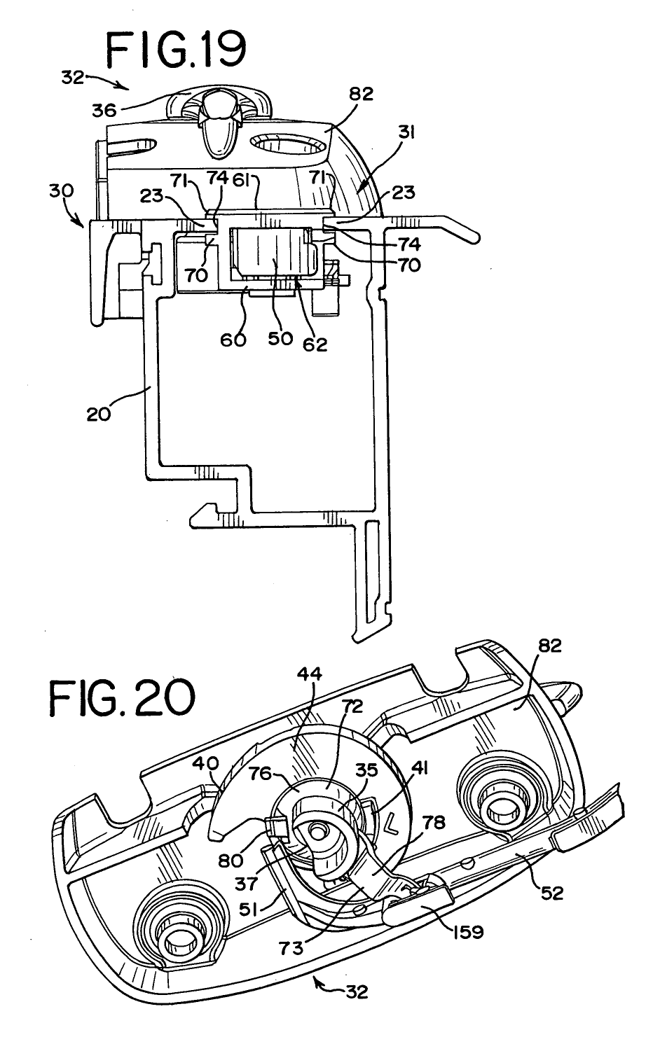

A second embodiment of an integrated tilt/sash lock assembly 30 is illustrated in FIGS. 11-27, and common elements of the second embodiment are similarly numbered to those above. Referring to FIGS. 14-19, the integrated tilt/sash lock assembly 30 generally includes a sash lock mechanism 32 and a tilt-latch mechanism 31. The sash lock mechanism 32 includes a cam or rotor 44 operably associated with a pawl 72 that has a pawl member 78. The tilt-latch mechanism 31 includes a housing 60 having a rear opening 68 and a latch bolt 50 disposed in the housing 60. A connector 52 also preferably forms part of the assembly 30. The connector 52 has a first end 54 operably associated with the sash lock mechanism 32 and preferably the pawl member 78, and a second end 56 passing through the rear opening 68 of the housing 60 and connected to the latch bolt 50.

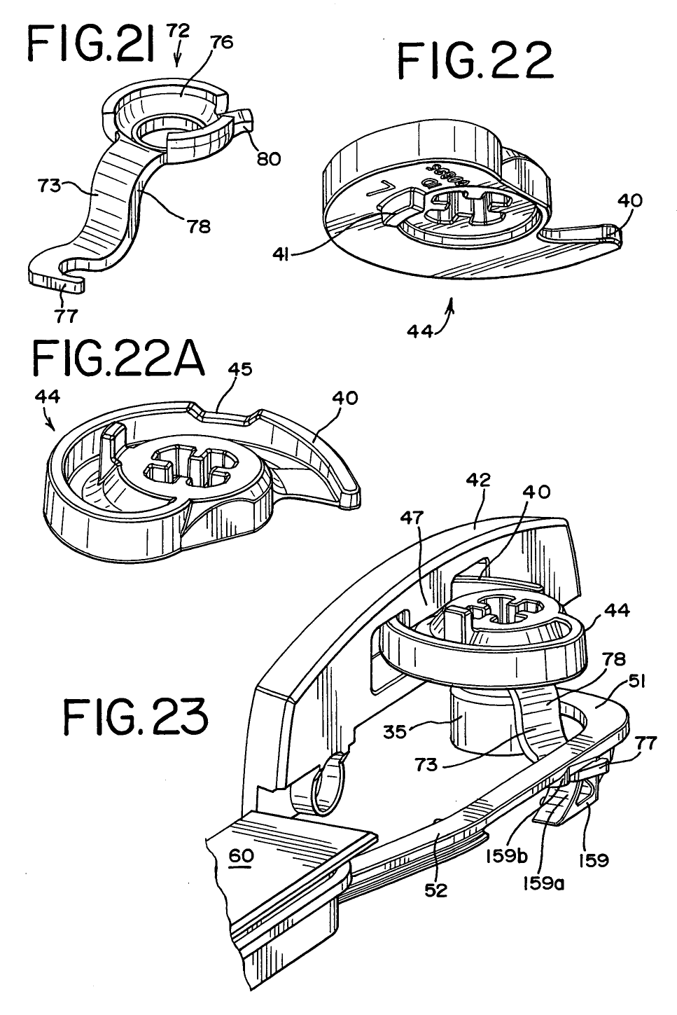

Referring to FIGS. 15-18, 20, and 23, the sash lock mechanism 32 includes an actuator arm 36 connected via a shaft 38 to a cam 44. A preferred embodiment of the cam 44 is illustrated in FIG. 22 and includes an abutment member 41 and a locking member 40 configured to engage a keeper or locking bracket 42 (FIG. 1). The sash lock mechanism 32 also includes a pawl 72. A preferred embodiment of the pawl 72 is illustrated in FIGS. 21 and 22A and includes a base 76 and a pawl member or appending member 78. The pawl 72 is operably associated with a connector 52 that extends away from the sash lock mechanism 32 to the tilt-latch mechanism 31. Preferably, the pawl 72 is directly connected to the connector 52, and the appending member 78 contains a hook 77 that engages a hitch 159 on the connector 52, as illustrated in FIGS. 15-18, 20 and 23. However, the hitch 159 of the second embodiment is different from the hitch 59 of the first embodiment. The hitch 159 of the second embodiment contains a retaining structure to hold the hook 77 in place, which includes a flexible lip 159a and a protrusion 159b. The combination of the lip 159a and the protrusion 159b force the hook 77 into the retaining structure and then hold the hook 77 in place once the hook 77 is engaged with the hitch 159, as best illustrated in FIG. 23. The hook 77 and/or the hitch 59,159 may also have another configuration.

The base 76 of the pawl 72 includes a tab 80 extending outwardly from an outer surface of the pawl 72. The cam 44 and the pawl 72 are disposed proximate one another in operable association with each other. Movement of the actuator arm 36 causes the cam 44 to rotate. Preferably, the cam 44 rotates freely and independently of the pawl 72 for a portion of the range of rotation. However, at a point in the rotation, the abutment member 41 of the cam 44 abuttingly engages the tab 80 of the pawl 72, such that when engaged, the cam 44 and the pawl 72 generally rotate in unison. Thus, the actuator 36, the cam 44, and the pawl 72 are all operably associated with each other.

A sash lock housing 82 covers and helps support the other components of the sash lock mechanism 32, and is designed to be attached to the top sash rail 20, as illustrated in FIG. 14. The sash lock housing 82 shown in FIG. 14 has a curved profile, unlike the “stepped” configuration of the sash lock housing 82 shown in FIG. 6. However, like the previously-described embodiment, the sash lock housing 82 is preferably configured to be mounted on the top sash rail 20 of the sash window 12. As shown in one embodiment illustrated in FIGS. 15, 16, and 19, the sash lock housing 82 may be disposed in a first location 83 of the sash rail 20 that is laterally offset from, or misaligned with, a second location 84 of the sash 20 rail in which the latch bolt housing 60 is disposed. In this embodiment, the appending member 78 of the pawl 72 extends downwardly and outwardly from the pawl base 76, and preferably includes a step portion 73. As shown in FIGS. 15, 16, and 19, the sash lock mechanism 32 is mounted proximate the first location 83, which is at a higher location in the top sash rail 20, preferably completely above the top sash rail 20. The base 76 of the pawl 72, as well as other components of the sash lock mechanism 32, are preferably mounted proximate the first location 83. The step portion 73 allows the latch bolt housing 60 to be mounted at the second location 84, which is at a lower depth in the rail 20 than the sash lock housing 82. Such a configuration facilitates a channel in the sash window rail 20 of sufficient depth to secure the latch bolt housing 60 with minimal compromise to the structural integrity of the rail 20. It is understood that the step portion 73 can vary for different assembly configurations, and that the appending member 78 of the pawl can extend downwardly and outwardly without a clearly defined step portion 73.

The interlocking between the cam or rotor 44 and the keeper 42 is illustrated in more detail in FIGS. 14 and 23. As shown in FIG. 14, the preferred keeper 42 has a projection 43 that is cooperatively dimensioned with a notch 45 in the rotor 44. When the notch 45 and the projection 43 are aligned, the projection 43 will slip into the notch 45, giving the user a “feel” indication that the assembly 30 is securely in the locked position. Additionally, the keeper 42 has a tongue 47 that interlocks with the locking member 40 of the rotor 44 to hold the sash window 12 more securely closed and give additional protection against forced entry.

The sash lock mechanism 32 illustrated in FIGS. 15-18, 20, and 23 additionally includes an asymmetrical cap 35 that is operably coupled to the actuator 36 to rotate with movement of the actuator 36. Preferably, the cap 35 is positioned on the bottom side of the pawl 72, opposite the rotor 44, protecting the pawl 72 and securing it to the sash lock mechanism 32. Additionally, the cap 35 is preferably asymmetrical and eccentric in shape, having a beveled portion 37. The cap 35 operates in a camming action with a curved arm 51 of the connector 52. As the actuator 36 is turned from the locked position, the cap 35 rotates. At some point along the rotation, the eccentric nature of the cap 35 causes the cap 35 to engage the arm 51 on the connector 52. Further rotation of the cap 35 exerts a force on the connector arm 51, pulling the connector 52 slightly, which in turn retracts the latch bolt 50 slightly. This permits the latch bolt 50 to begin retraction prior to the point where the rotor 44 abuttingly engages the pawl 72.

Referring to FIGS. 15-19 and 24-26, the tilt-latch mechanism 31 includes a latch bolt 50 disposed within a housing 60 and coupled to the connector 52 and a means for biasing the latch bolt outwardly, which is preferably a spring 63. It is understood the spring 63 is generally positioned between the latch bolt 50 and the housing 60 to bias the latch bolt 50 out of the housing 60. The housing 60 is used to support the latch bolt 50 in the top sash rail 20, and is preferably flush-mounted within the top sash rail 20, as shown in FIGS. 14 and 19. The latch bolt 50 is able to slide within the housing 60 between a retracted position, wherein the tip 57 of the latch bolt 50 is retracted into the housing 60, and an outwardly-extended position, wherein the tip 57 of the latch bolt 50 extends beyond the end of the housing 60 and beyond the edge of the stile 24,26. When the sash window 12 is closed, the latch bolt 50 engages one of the guide rails 16 in the outwardly-extended position. The spring biases the latch bolt 50 towards the outwardly-extended position. The connector 52 connects to the latch bolt 50, preferably by a snap-fit connection 55, as illustrated in FIGS. 17-18 and 24-25. The latch bolt 50 preferably has a recess 55a to receive the end 56 of the connector 52 and create the snap-fit connection 55.

A preferred housing 60 is illustrated alone in FIG. 26. The body 65 of the housing 60 preferably includes a cover 61, a pair of side walls 67 depending from the cover 61, and a bottom wall 69 extending inward from the side wall 67. The cover 61 is preferably rectangular in shape and has an outer edge 71 overhanging the side wall 67, so that the side wall 67 depends inward from the outer edge 71. The side wall 67 is preferably straight along the sides of the housing 60. The housing 60 also has a rear wall 67a curved along the back end of the housing 60. At the front end of the housing 60, a gap in the side wall 67 preferably exists to form a front opening 62 that allows the latch bolt 50 to extend out of the housing 60. The housing 60 preferably has at least one continuous longitudinal rail extending along the side wall 67, and preferably has two continuous longitudinal rails 70, each extending down one side of the side wall 67. The housing 60 may also have a continuous single rail 70 that extends completely along the side walls 67 and rear wall 67a, or the rail or rails 70 may be broken or otherwise non-continuous. In the preferred embodiment, a continuous longitudinal groove 74 extending along the side wall 67 is formed between the rails 70 and the edge 71 of the cover 61. Like the rail(s) 70, the groove 74 may be continuous or broken, and may consist of several separate grooves 74. The combination of the rail 70 and groove 74 functions to support the housing 60 within the sash window 12. Preferably, a portion 23 of the top sash rail 20 is received in each groove 74. The mounting of the tilt latch mechanism 31 in the sash window 12 is illustrated in more detail in FIGS. 14 and 19. It is understood that the housing 60 may have a different shape or configuration, and may have another manner and structure for mounting within the sash window 12.

Additionally, the housing 60 preferably contains a rear opening 68, allowing the connector 52 to pass through and connect to the latch bolt 50. The rear opening 68 is defined within the rear wall 67a of the housing 68, opposite the tip 57 of the latch bolt 50, and is preferably a rectangular hole, as illustrated in FIG. 26. In the preferred embodiment, the opening 68 is completely within the rear wall 67a, i.e. the opening 68 is surrounded on all sides by the material of the rear wall 67a. In another embodiment, the opening 68 can extend into the side wall 67, rear wall 67a, and the cover 61. However, the rear opening 68 can also take the form of a slot or a groove in the rear portion of the housing which extends completely through to the bottom of the rear wall 67a, and can be shaped differently as well. The opening 68 can also be positioned in other portions of the housing 68.

The housing 60 illustrated in FIG. 26 has a stile-engaging member 164 that is different from the stile-engaging member 64 of the embodiment described above. The stile-engaging member 164 of the present embodiment includes a flexible tab that depends from the bottom wall 69 of the housing 60 and engages the stile 24,26 to hold the tilt latch 31 within the sash window. It is understood that the stile engaging member 64 described above could be incorporated into the housing 60 of FIG. 26.

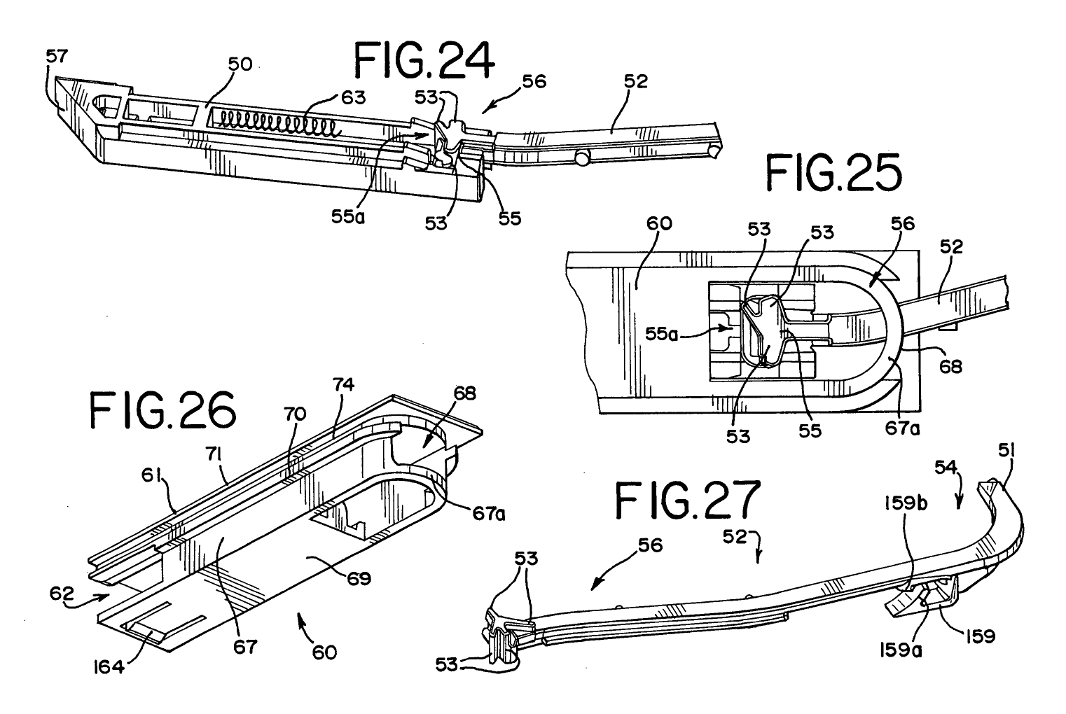

The connector 52 preferably connects the tilt-latch mechanism 31 and the sash lock mechanism 32, and has a first end 54 and a second end 56. A preferred embodiment of the connector is shown in FIGS. 15-18 and 23-25, and is illustrated alone in FIG. 27. The first end 54 of the connector 52 is operably associated with the sash lock mechanism and preferably the pawl 72, and also preferably by engaging the appending member 78 of the pawl 72. As described above, the connector 52 preferably has a hitch 159 that engages a hook 77 on the appending member 78 of the pawl 72. The second end 56 of the connector 52 is connected to the latch bolt 50, preferably by passing through the rear opening 68 of the housing 60 and forming a snap-fit connection 55 with the latch bolt, as described above and illustrated in FIGS. 24-25. According to one embodiment of the present invention, the connectors 52 are flexible cords. It is preferred, however, that the connectors 52 are instead rigid or semi-flexible connecting rods. The rigid or semi-flexible connector 52 preferably has a bend in the middle to prevent interference between the connector 52 and mounting structure for the sash lock mechanism 32. As illustrated in FIGS. 24-25 and 27, the second end 56 of the connector 52 preferably has several resilient bracing arms 53 extending therefrom. When the connector end 56 is snapped into the latch bolt 50, the bracing arms 53 exert directional forces on the latch bolt 50, thus bracing the connector 52 against excessive movement during operation of the assembly 30. In particular, the bracing arms 53 exert a downward force or torque on the connector 52, tending to push the first end 54 of the connector downward. Pushing the first end 54 of the connector downward helps assure that the connector 52 remains in the proper position for connection to the sash-lock mechanism 32, facilitating a user in making a blind connection between the two. Additionally, as described above, the connector 52 shown in FIG. 27 contains a curved arm 51 extending from the first end 54 of the connector 52, which interacts with the cap 35 of the sash lock mechanism 32.

The operation of the first embodiment of the assembly 30 shown in FIGS. 1-10 and the second embodiment of the assembly 30 shown in FIGS. 11-27 is generally the same. As described above and illustrated in FIGS. 11-13, the assembly 30 is operable between a locked position, an unlocked position, and a tiltable position. The actuator arm 36 of the present invention is operable between locked, unlocked and tiltable positions, adjusting the assembly 30 between the three positions. It is contemplated that the actuator arm 36 can include some indicia thereon for assisting a user during operation. When the actuator is in the locked position, illustrated in FIG. 11, the locking member 40 engages the locking bracket 42 (See also FIG. 23) and the latch bolt 50 is in the outwardly-extended position. Thus, the sash window 12 is prevented from vertically opening and from tilting. In this position, the cam 44 and the pawl 72 are not engaged with each other, and the cam 44 moves freely and independently of the pawl 72.

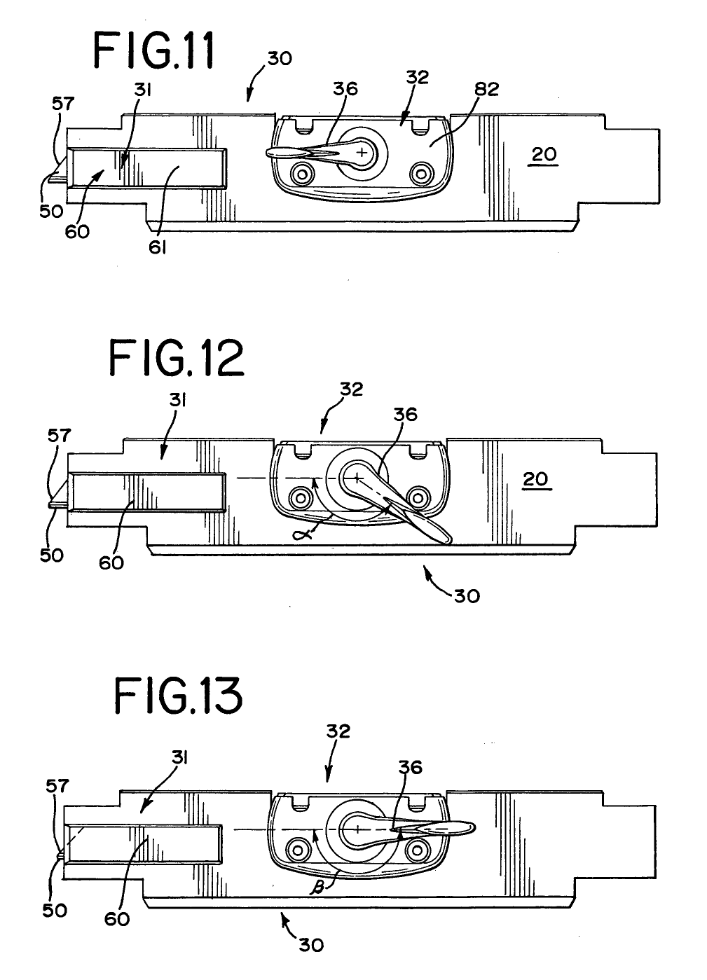

When the actuator arm 36 is moved from the locked position to the unlocked position, shown in FIG. 12, the cam 44 is rotated to a first angle α from the locked position. This rotation disengages the locking member 40 from the keeper or locking bracket 42, permitting the sash window to vertically open. However, the latch bolt 50 remains outwardly extended into the guide rail 16, and thus, the sash window 12 continues to be prevented from tilting. Preferably, in the unlocked position, the tab 80 of the pawl 72 is not yet abuttingly engaged by the cam 44, and the pawl 72 abuttingly engages the cam 44 immediately upon further rotation. However, the cam 44 and the pawl 72 may abuttingly engage prior to the actuator 36 reaching the unlocked position, simultaneously with the unlocked position, or significantly after the actuator 36 passes the unlocked position. Additionally, a spring within the latch bolt housing 60 may bias the cam 44 toward the unlocked position.

When the actuator arm 36 is moved from the unlocked position to the tiltable position, shown in FIG. 13, the cam 44 is rotated to a second angle β from the locked position, wherein the second angle β is greater than the first angle α. In the tiltable position, the locking cam 44 remains disengaged from the locking bracket 42, still permitting the sash window to vertically open. However, the cam 44 has abuttingly engaged the tab 80 extending from the pawl 72, causing the pawl 72 to rotate in unison with the cam 44. Further rotation of the pawl 72 pulls the connector 52, which in turn pulls the latch bolt 50 toward the retracted position. In this retracted position, the latch bolt 50 is released from the guide rail 16, permitting the sash window 12 to tilt about the pivot corner 15.

Viewed another way, the assembly 30 is moveable through a first range of angular movement, where movement of the actuator 36 rotates the rotor 44, and a second range of angular movement, where the rotor 44 abuttingly engages the pawl 72 such that movement of the actuator 36 rotates the rotor 44 and the pawl 72 together. In a preferred embodiment, the actuator handle 36 is moveable among a first position, where the cam or rotor 44 does not abuttingly engage the pawl 72 and the assembly is in the locked position, a second position where the cam 44 abuttingly engages the pawl 72 and the assembly is in the unlocked position, and a third position where the cam 44 abuttingly engages the pawl 72 where the connector 52 retracts the latch bolt 50 wherein the assembly is in the tiltable position. It is understood that the assembly 30 and the actuator 36 may have several positions which are “locked,” “unlocked,” and “tiltable” positions, dictated by the function of the window at the respective position. It is also understood that the sequence of mechanical interactions within the assembly 30 may be varied. Thus, depending on the configuration of the assembly 30, there may be additional positions where, for example, the assembly is in the locked position and the cam 44 is already abuttingly engaging the pawl 72; or, in an alternate embodiment of the assembly, where the assembly is in the unlocked position but the cam 44 has not yet abuttingly engaged the pawl 72.

When operating the actuator arm 36 in reverse to the above, the actuator arm 36 is moved from the tiltable position to the unlocked position, and the cam 44 is rotated back to the first angle. The locking member 40 remains disengaged from the locking bracket 42, still permitting the sash window to vertically open. In the unlocked position, the latch bolt 50 moves back to the outwardly-extended position due to the bias created by the spring 63. This movement is made possible because the pawl 72 is no longer is engaged with, and rotatably biased by, the cam 44 and does not pull the latch bolt 50 toward the retracted position. Thus, the sash window is prevented from tilting.

When the actuator arm 36 is moved from the unlocked position to the locked position, the locking member 40 engages the locking bracket 42, preventing the sash window 12 from opening. Thus, the sash window 12 is still prevented from tilting, and the latch bolt 50 provides additional security against opening of the window.

The actuator arm 36 and the upper side of the cam 44 may include cooperating structures, such that the integrated assembly 30 produces an audible click whenever the actuator arm reaches any of the locked, unlocked, or released positions.

The assembly 30 provides many benefits. The tilt latch mechanism 31 is flush-mounted in the top sash rail 20, providing a more aesthetically-pleasing look, as well as securing the tilt latch 31 more tightly to the top rail 20. The rear opening 68 of the tilt latch housing 60 provides simple access for the connector 52 to permit integrated operation of the tilt latch mechanism 31 and the sash lock mechanism 32. Traditionally, tilt latch housings have not been provided with such openings, as they were unnecessary because such tilt latches did not operate integrally with a sash lock mechanism. The stile-engaging member 64 advantageously permits the tilt latch 31 to be installed in differently sized windows 12, having stiles 24,26 of differing thicknesses. This reduces the need for manufacturing several different types of housings 60, each having a stile-engaging member at a different location, for different types of sash windows 12. Further, the design of the appending member 78 of the pawl 72 allows the sash lock mechanism 32 to be installed at a location 83 in the sash window 12 vertically offset from the location 84 of the tilt latch mechanism 31. As stated above, this configuration facilitates a channel in the sash window rail 20 of sufficient depth to secure the latch bolt housing 60 with minimal compromise to the structural integrity of the rail 20.

While the specific embodiments have been illustrated and described, numerous modifications come to mind without significantly departing from the spirit of the invention and the scope of protection is only limited by the scope of the accompanying Claims.

What is claimed is:

1. An integrated sash lock and tilt latch assembly for a sash window having a top rail, a base, and two stiles connected together at their extremities, the integrated assembly comprising:
a sash lock mechanism comprising:
an actuator movable to adjust the assembly among a locked position, an unlocked position, and a tiltable position,
a rotor coupled to the actuator, the rotor having a locking cam, and
a keeper that receives at least a portion of the locking cam in the locked position;
a tilt latch mechanism comprising:
a latch bolt housing adapted to be supported by the top rail, wherein a top surface of the latch bolt housing is substantially flush with a top surface of the top rail,
a latch bolt slidably disposed within the latch bolt housing, and
means for biasing the latch bolt outwardly from the housing; and
a connector having a first end and a second end, wherein the first end of the connector is operably coupled to the sash lock mechanism and the second end of the connector is operably coupled to the latch bolt.

2. The integrated sash lock and tilt latch assembly of claim 1, wherein the latch bolt housing further comprises a longitudinal groove adapted to receive a header rail of the top rail to support the latch bolt housing within a cavity in the sash window.

3. The integrated sash lock and tilt latch assembly of claim 2, wherein the groove is continuous along a side wall of the housing.

4. The integrated sash lock and tilt latch assembly of claim 1, wherein the latch bolt housing further comprises an opening receiving the connector therethrough.

5. The integrated sash lock and tilt latch assembly of claim 4, wherein the latch bolt housing further comprises a cover and a rear wall depending from the cover, and the opening is positioned in the rear wall.

6. The integrated sash lock and tilt latch assembly of claim 1, wherein the latch bolt housing further comprises a longitudinal rail adapted to be received in a slot in the sash window to support the latch bolt housing within a cavity in the sash window.

7. The integrated sash lock and tilt latch assembly of claim 6, wherein the latch bolt housing further comprises a cover having a longitudinal edge, wherein the longitudinal edge and the longitudinal rail define a longitudinal groove therebetween, the longitudinal groove configured to receive a header rail of the top rail to support the latch bolt housing within the cavity in the sash window.

8. The integrated sash lock and tilt latch assembly of claim 1, wherein the sash lock mechanism further comprises a pawl operably associated with the actuator, wherein the pawl operably engages the rotor and the second end of the connector is connected to the pawl.

9. The integrated sash lock and tilt latch assembly of claim 8, wherein the pawl comprises a base having a tab and an appending member extending therefrom, and wherein the rotor abuttingly engages the tab and the second end of the connector is connected to the appending member.

10. The integrated sash lock and tilt latch assembly of claim 8, wherein the actuator is moveable among a first position wherein the rotor does not abuttingly engage the pawl and the assembly is in the locked position, a second position wherein the rotor abuttingly engages the pawl and the assembly is in the unlocked position, and a third position wherein the rotor abuttingly engages the pawl and the assembly is in the tiltable position.

11. The integrated sash lock and tilt latch assembly of claim 10, wherein the abutting engagement of the rotor and the pawl causes the rotor and the pawl to rotate together between the second position and the third position.

12. The integrated sash lock and tilt latch assembly of claim 8, wherein the actuator is moveable through a first range of angular movement, wherein movement of the actuator rotates the rotor, and a second range of angular movement, wherein the rotor abuttingly engages the pawl such that movement of the actuator rotates the rotor and the pawl together.

13. The integrated sash lock and tilt latch assembly of claim 1, wherein the latch bolt housing further comprises a stile-engaging member extending from the housing and having a plurality of engaging surfaces thereon, each of the engaging surfaces configured to engage an inner surface of one of the stiles.

14. The integrated sash lock and tilt latch assembly of claim 13, wherein the stile-engaging member comprises a flexible and resilient leg extending from the housing, and the leg is configured to flex when the housing is inserted into the top sash rail.

15. The integrated sash lock and tilt latch assembly of claim 14, wherein the latch bolt housing further comprises a cut-out portion proximate the leg, the cut-out portion allowing the leg to flex upwardly.

16. An integrated sash lock and tilt latch assembly for a sash window, the integrated assembly comprising:
an actuator movable to adjust the assembly among a locked position, an unlocked position, and a tiltable position;
a rotor coupled to the actuator, the rotor having a locking cam;
a pawl comprising a base and an appending member extending downward and outward from the base;
a keeper that receives at least a portion of the locking cam in the locked position;
a latch bolt slidably disposed within the sash window;
means for biasing the latch bolt outwardly; and
a connector having a first end and an opposed second end, wherein the first end of the connector is operably coupled to the appending member of the pawl and the second end of the connector is operably coupled to the latch bolt,
wherein the actuator is moveable among a first position wherein the rotor does not abuttingly engage the pawl and the assembly is in the locked position, a second position wherein the assembly is in the unlocked position, and a third position wherein the rotor abuttingly engages the pawl and the assembly is in the tiltable position.

17. A tilt latch housing for a sash window having a top rail, a base, and two stiles connected together at their extremities, the housing configured to be supported by the top rail proximate one of the two stiles and comprising:
a body configured to slidably receive a latch bolt therein; and
a stile-engaging member extending from the body and having a plurality of engaging surfaces thereon, each of the engaging surfaces configured to engage an inner surface of the stile.

18. The tilt latch housing of claim 17, wherein the stile-engaging member comprises a flexible and resilient leg extending from the housing, and the leg is configured to flex when the housing is inserted into the top sash rail.

19. The tilt latch housing of claim 18, wherein the body further comprises a cut-out portion proximate the leg, the cut-out portion allowing the leg to flex upwardly.

20. The tilt latch housing of claim 17, wherein the plurality of engaging surfaces comprises a plurality of teeth substantially aligned along a length of the stile-engaging member.

21. The tilt latch housing of claim 17, wherein the housing further comprises a longitudinal groove adapted to receive a portion of the sash window to support the housing within the sash window

22. The tilt latch housing of claim 17, wherein the housing further comprises an opening configured to receive a connector therethrough.

23. The tilt latch housing of claim 17, wherein the housing further comprises a longitudinal rail attached to the body and adapted to be received in a slot in the sash window to support the housing within the sash window.

24. An integrated sash lock and tilt latch assembly for a sash window assembly, the sash window assembly having a lower sash window and an upper sash window slideable within a master frame, the lower sash window having a top rail, a base and a pair of stiles connected together at their extremities, the top rail having a pair of header rails, the upper sash window having a keeper, the sash lock and tilt latch assembly comprising:
a sash lock mechanism comprising:
an actuator adapted to be supported by the lower sash window, and
a rotor connected to the actuator;
a tilt latch mechanism comprising:
a latch bolt housing having mounting structure adapted to receive the header rails of the top rail of the lower sash window,
a latch bolt slidably disposed within the latch bolt housing, and
means for biasing the latch bolt outwardly from the housing; and,
a connector having a first end and a second end, wherein the first end of the connector is operably coupled to the sash lock mechanism and the second end of the connector is operably coupled to the latch bolt,
the actuator having a locked position wherein the rotor is adapted to engage the keeper, the actuator being moveable to an unlocked position wherein the rotor is adapted to be disengaged from the keeper, and being further moveable to a tiltable position wherein the connector retracts the latch bolt into the latch bolt housing.

25. The integrated sash lock and tilt latch assembly of claim 24, wherein the latch bolt housing has a pair of side walls, each side wall having a groove adapted to receive a header rail of the top rail.

26. The integrated sash lock and tilt latch assembly of claim 24, wherein the latch bolt housing has a rear wall having an opening, wherein the connector extends through the opening.

27. The integrated sash lock and tilt latch assembly of claim 24, wherein the latch bolt housing has a stile-engaging member having a plurality of engaging surfaces thereon, each of the engaging surfaces adapted to engage an inner surface of the stile.
